(19) United States
(12) Patent Application Publication
(10) Pub. No.: US 2005/0128891 A1
(43) Pub. Date: Jun. 16, 2005

(54) Method for controlling the disc ejecting operation in an optical disc drive

(75) Inventors: Tsung-Jung Kuo, Hsinchu (TW); Jui-Chiang Lin, Hsinchu (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: Lite-On It Corporation

(21) Appl. No.: 11/006,009

(22) Filed: Dec. 7, 2004

(30) Foreign Application Priority Data
Dec. 12, 2003 (TW) 92135166

(51) Int. Cl. G11B 7/085

(52) U.S. Cl. 369/30.27

(57) ABSTRACT

This invention discloses a method for controlling the disc ejecting operation in an optical disc drive. A pulling mechanism in an optical disc drive is moved to contact the disc after receiving an ejection command. Then the ejection preparation is executed to avoid the instability of the disc due to the contact of the pulling mechanism. After the ejection preparation, the pulling mechanism is driven to eject the disc by detecting the output signal of the second sensor. The pulling mechanism stops driving if the output of the second sensor turns to a HIGH level output. Then the ejecting operation is completed.

### BACKGROUND OF THE INVENTION

1. Field of the Invention

The present invention relates to optical disc drives, and more particularly, to a method for controlling the disc ejecting operation in an optical disc drive.

2. Description of the Related Art

With the developments of information technology and the widespread utilization of multimedia contents, the demanding for data storage solutions with high capacities and low costs raises day by day. Among all the data storage solutions, the optical discs are becoming more and more important for backing up data and exchanging information due to many advantages that the optical storage media have that includes a high data capacity, portability, and a long lifetime for preserving information. Currently, the optical disc drives are widely used such in desktop computers, laptop computers, DVD players, and some instruments or electronic products with built-in microprocessors.

Generally speaking, an optical disc drive loads or ejects an optical disc by utilizing a disc loading mechanism of the optical disc drive. After loading the optical disc into the optical disc drive, the optical disc is fixed to a turntable of a spindle motor for further data access. Besides the conventional tray loading mechanism, the slot loading mechanism is getting more and more popular for its convenience. It is quite handy for users to just insert a disc slightly into the loading/ejecting slot, and then the slot loading mechanism of the optical disc drive takes over the following loading process. Moreover, while loading or ejecting a disc with the slot loading mechanism, the slot loading mechanism can hold the disc firmly throughout all the loading or ejecting process. Thus it makes the slot loading mechanism especially suitable for using in a moving or vibrating environment such as car-use CD audio players and databases for GPS navigators.

Please refer to FIG. 1. FIG. 1 is a top view for illustrating the relation between various elements in an optical disc drive with slot loading mechanism of the prior art after a disc has been loaded. A prior art optical disc drive 100 has a loading/ejecting slot 102, a first sensor 112 disposed at a first sensing position for detecting if a disc passing the first sensing position, and a second sensor 114 disposed at a second sensing position for detecting if a disc passing the second sensing position. There are also two round contours in FIG. 1 for showing the positions of two regular sizes of the loaded optical disc: one is for a larger disc with 12 cm diameter 120, and the other is for a smaller disc with 8 cm diameter 130. The first sensor 112 is designed to trigger the loading operation. Furthermore, after a disc is loaded into the disc drive, the disc is fixed on a turntable 108 of the spindle motor. A logical element (Not Shown) manages the status of the loading/ejecting operation according to the outputs of the first and the second sensors and controls a motor (Not Shown) to drive a roller 104 via a gear set 106 to load or eject the optical disc. The roller 104 is used to convey optical discs into or out of the disc drive according to the rotating direction of the roller. The position of the roller 104 is set to overlap with the covering range of both the 8 cm disc 130 and the 12 cm disc 120 to ensure that the roller 104 can convey those tow kinds of discs with different radiuses as specified in the specification.

The sensors as mentioned above can be electronic switches that includes leaf springs or rods with a HIGH level and a LOW level logical states for indicating whether a disc has been detected. And in the preferred embodiment, the above mentioned sensors are optical sensors that each has an emitter and a receiver to emit and receive a light beam, respectively. For example, when a disc is passing an optical sensor, the light beam from the emitter is blocked by the disc and the sensor has an output at the LOW level. On the other hand, when the sensor is not blocked by the disc, the sensor has an output at the HIGH level. Of course the output levels of a sensor can be easily redesigned to have a HIGH level output when the sensor is blocked, and to have a LOW level output when the sensor is not blocked. Furthermore, the logical element for managing the loading and ejecting operations can be a hard-wired logic circuitry or a microprocessor executing a firmware. And in some embodiments, the logical element can even share the same PCB with the first and the second sensor.

Moreover, the second sensor 114 is used to control the ejecting operation and the ejecting operation is executed by pressing the eject button in the slot loading mechanism. When the ejecting operation is executed, the second sensor 114 is blocked by the disc and the output level of the second sensor 114 is designed to have a LOW level output. After the ejecting operation is completed, the second sensor 114 is not blocked by the disc and the output level of the second sensor 114 is redesigned to have a HIGH level output.

Now refer to FIG. 2, FIG. 2 is a flow chart for illustrating the ejecting operation in the optical disc drive with slot loading mechanism of the prior art. When the ejecting operation is executed, an ejection command is received in the optical disc drive with slot loading mechanism and the pulling mechanism such as a roller is driven to contact the disc as step 201 and 202 in FIG. 2. Then, the output of the second sensor is detected as step 203. If the output level of the second sensor is a HIGH level output (sensor unblocked), the progress goes back to step 201 to wait for the next ejection command. Otherwise, if the output level of the second sensor is a LOW level output (sensor blocked), the pulling mechanism is driven to eject the disc as step 204. Following, the progress moves into step 205 for detecting the output of the second sensor before the ejecting operation is completed. If the output level of the second sensor is keeping at a LOW level output (sensor blocked), the progress goes back to step 204 to keep driving the pulling mechanism to eject the disc. Once the output level of the second sensor is detected as a HIGH level output (sensor unblocked), the ejecting operation is completed as step 206.

Please refer to FIG. 3. FIG. 3 is a timing flow for performing the ejecting operation in the optical disc drive with slot loading mechanism of the prior art. Wherein, when the second sensor is blocked by the disc, the output level of the second sensor is designed to have a LOW level output as illustrated in FIG. 3. When the second sensor is unblocked, the output level of the second sensor is redesigned to have a HIGH level output. As illustrated in FIG. 3, point A indicates that an ejection command is received and the output of the second sensor is detected. Generally speaking, the detected output of the second sensor of point A is suggested to have a LOW level output which indicates the second sensor blocked by the disc and the pulling mechanism is moved to contact the disc for perform an ejecting operation. Accordingly, point B indicates that the output of the second sensor is transformed to a HIGH level from a LOW level, which means that the second sensor is not blocked by the disc and the ejecting operation is completed.

However, vibration arises while the pulling mechanism is contacting the disc and the disc shakes and slides due to the vibration. Furthermore, the second sensor is placed at a second sensing position for detecting if both the 8 cm disc and the 12 cm disc passing the second sensing position. As illustrated in FIG. 1, the second sensing position is disposed at the outer boundary of the 8 cm disc. Due to the sensitivity of the second sensing position and the instability of the disc such as shake and slide, the detected output of the second sensor of point A may not be a LOW level output, which means that the ejecting operation is stop though an ejection command is received. On the other hand, the ejecting operation can not be completed if the users execute the ejecting operation.

### SUMMARY OF THE INVENTION

Accordingly, it is an object of the present invention to provide a method for controlling the disc ejecting operation in an optical disc drive by utilizing a logical element for managing the ejecting operation according to the output of a second sensor and controlling a motor to drive a pulling mechanism to eject the optical disc. Furthermore, the first logical state is a HIGH level logical state and the second logical state is a LOW level logical state. The second sensor is optical sensor and output a HIGH level or LOW level logical states to indicate if a disc has been detected.

In one embodiment of the present invention, a pulling mechanism in an optical disc drive is moved to contact the disc after receiving an ejection command. Then the ejection preparation is executed to avoid the instability of the disc due to the contact of the pulling mechanism. After the ejection preparation, the pulling mechanism such as a roller is rolled to eject the disc by detecting the output signal of the second sensor. The rolling of the pulling mechanism stops if the output of the second sensor turns to a HIGH level output. Then the ejecting operation is completed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a top view for illustrating the relation between various elements in an optical disc drive with slot loading mechanism of the prior art after a disc has been loaded.

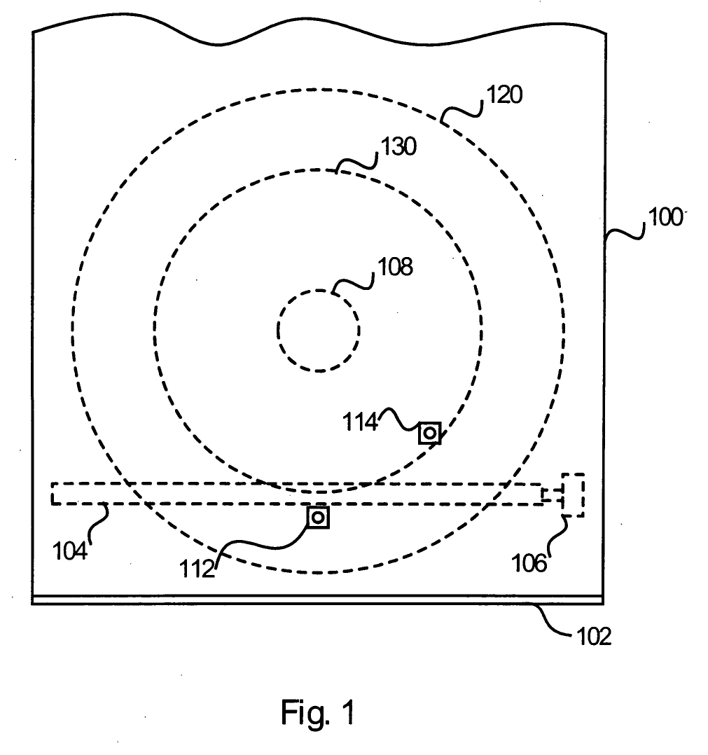

FIG. 2 is a flow chart for illustrating the ejecting operation in the optical disc drive with slot loading mechanism of the prior art

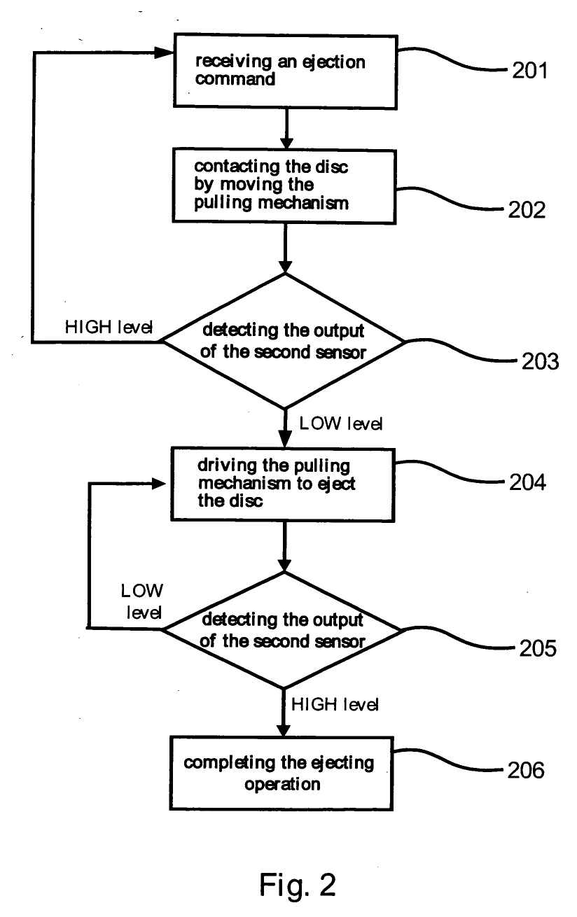

FIG. 3 is a timing flow for performing the ejecting operation in the optical disc drive with slot loading mechanism of the prior art

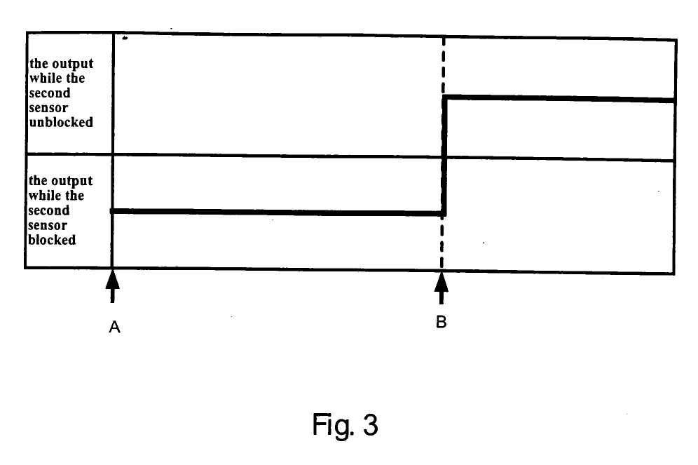

FIG. 4 is a flow chart for illustrating the ejecting operation in the optical disc drive with slot loading mechanism according to the present invention.

FIG. 5 is a timing flow for performing the ejecting operation in the optical disc drive with slot loading mechanism according to the present invention.

### DESCRIPTION OF THE EMBODIMENTS

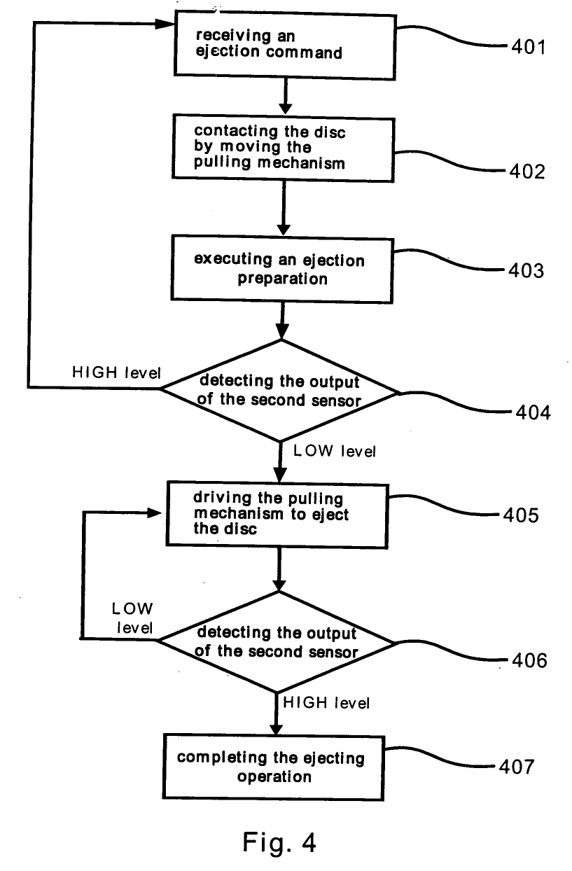

Please refer to FIG. 4. FIG. 4 is a flow chart for illustrating the ejecting operation in the optical disc drive with slot loading mechanism according to the present invention, comprising the following steps:
step 401: receiving an ejection command;
step 402: contacting the disc by moving the pulling mechanism;
step 403: executing an ejection preparation;
step 404: detecting the output of the second sensor;
step 405: driving the pulling mechanism to eject the disc;
step 406: detecting the output of the second sensor; and
step 407: completing the ejecting operation
   When the ejecting operation is executed, an ejection command is received in the optical disc drive with slot loading mechanism and the pulling mechanism such as a roller is driven to contact the disc as step 401 and 402 in FIG. 4. Additionally, an ejection preparation is executed as step 403 before detecting the output of the second sensor. The ejection preparation is used to solve the instability of the disc such as shake and slide. Since the instability of the disc due to the contact by the pulling mechanism will last for a period of time (T1), the ejection preparation is designed to wait for a predetermined time (T2) to ensure the stability of the disc for the correct output of the second sensor.

As a result, the disc shake and slide due to the contact of the pulling mechanism would last for a period of time (T1) and the disc shake and slide would lead to the incorrect output of the second sensor. For ensuring the stability of the disc, an ejecting preparation is executed and the output of the second sensor is detected after the ejecting preparation. The ejecting preparation is executed for a predetermined time (T2) which is determined by being larger than the period of time (T1) during which disk is shaking and sliding. T1 and T2 are designed to satisfy the following relationship:
T2>T1
Therefore, the output of the second sensor in the following step 404 would be ensured to have a LOW level output so as to drive the pulling mechanism to eject the disc.

Following, the output of the second sensor is detected as step 404. If the output level of the second sensor is a HIGH level output (sensor unblocked), the progress goes back to step 401 to wait for the next ejection command. Otherwise, if the output level of the second sensor is a LOW level output (sensor blocked), the pulling mechanism is driven to eject the disc as step 405. Then, the progress moves into step 406 for detecting the output of the second sensor before the ejecting operation is completed. If the output level of the second sensor is keeping at a LOW level output (sensor blocked), the progress goes back to step 405 to keep driving the pulling mechanism to eject the disc. Once the output level of the second sensor is detected as a HIGH level output (sensor unblocked), the ejecting operation is completed as step 407.

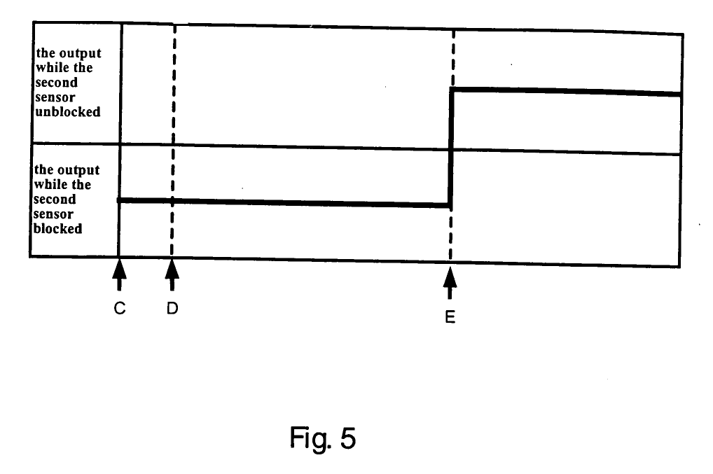

Now refer to FIG. 5. FIG. 5 is a timing flow for performing the ejecting operation in the optical disc drive with slot loading mechanism according to the present invention. Wherein, when the second sensor is blocked by the disc, the output level of the second sensor is designed to have a LOW level output. When the second sensor is unblocked, the output level of the second sensor is redesigned to have a HIGH level output. As illustrated in FIG. 5, point C indicates that an ejection command is received and the output of the second sensor is detected. Generally speaking, the detected output of the second sensor of point C is suggested to have a LOW level output which indicates the second sensor blocked by the disc and the pulling mechanism is moved to contact the disc for perform an ejecting operation.

However, the disc shake and slide due to the contact of the pulling mechanism would lead to the incorrect output of the second sensor of point C. Furthermore, the disc shake and slide would last for a period of time (T1). For ensuring the stability of the disc, an ejecting preparation executed and the output of the second sensor is detected at point D. The ejecting preparation is executed from point C to point D, wherein, point D delays a predetermined time (T2) in comparison to point C since the predetermined time (T2) is determined by being larger than the period of time (T1) during which disk is shaking and sliding. T1 and T2 are designed to satisfy the following relationship:
T2>T1
As a result, the output of the second sensor of point D would be ensured to have a LOW level output so as to drive the pulling mechanism to eject the disc. Accordingly, point E indicates that the output of the second sensor is transformed to a HIGH level from a LOW level, which means that the second sensor is not blocked by the disc and the ejecting operation is completed.

Therefore, the ejection preparation is provide in this invent to avoid the instability of the disc due to the contact of the pulling mechanism. Moreover, the output of the second sensor would be more reliable. When an ejection command is received, the ejecting operation can be executed successfully. Accordingly, the ejecting operation can be completed if the users execute the ejecting operation.

While the present invention has been particularly shown and described with reference to a preferred embodiment, it will be understood by those skilled in the art that various changes in form and detail may be without departing from the spirit and scope of the present invention.

1. A method for controlling the disc ejecting operation in an optical disc drive by utilizing a pulling mechanism in the optical disc drive to eject a disc, the method comprising:
moving the pulling mechanism to contact the disc;
executing an ejection preparation for stability of the disc; and
driving the pulling mechanism to eject the disc in accordance with an output of a sensor.

2. The method for controlling the disc ejecting operation in an optical disc drive according to claim 1, wherein the optical disc drive is a slot loading mechanism.

3. The method for controlling the disc ejecting operation in an optical disc drive according to claim 1, wherein the pulling mechanism is a roller.

4. The method for controlling the disc ejecting operation in an optical disc drive according to claim 3, wherein the roller is rolled to eject the disc when the output of the sensor has a first level output.

5. The method for controlling the disc ejecting operation in an optical disc drive according to claim 4, wherein the first level output is a LOW level output.

6. The method for controlling the disc ejecting operation in an optical disc drive according to claim 3, wherein the roller stops to eject the disc when the output of the sensor has a second level output.

7. The method for controlling the disc ejecting operation in an optical disc drive according to claim 6, wherein the second level output is a HIGH level output.

8. The method for controlling the disc ejecting operation in an optical disc drive according to claim 1, wherein the ejection preparation is to wait for a predetermined time.

9. The method for controlling the disc ejecting operation in an optical disc drive according to claim 8, wherein the predetermined time is designed to be larger than a period of time during which the disc lasts shaking and sliding.

10. A method for controlling the disc ejecting operation in an optical disc drive by utilizing a pulling mechanism in the optical disc drive to eject a disc, the method comprising:
moving the pulling mechanism to contact the disc;
executing an ejection preparation before detecting an output of a sensor; and
driving the pulling mechanism to eject the disc in accordance with the output of the sensor.

11. The method for controlling the disc ejecting operation in an optical disc drive according to claim 10, wherein the ejection preparation is to wait for a predetermined time T2.

12. The method for controlling the disc ejecting operation in an optical disc drive according to claim 11, wherein the predetermined time T2 is designed to be larger than a period of time T1 during which the disc lasts shaking and sliding.

13. The method for controlling the disc ejecting operation in an optical disc drive according to claim 10, wherein the pulling mechanism is a roller.

14. The method for controlling the disc ejecting operation in an optical disc drive according to claim 13, wherein the roller is rolled to eject the disc when the sensor is blocked by the disc.

15. The method for controlling the disc ejecting operation in an optical disc drive according to claim 13, wherein the roller stops to eject the disc when the sensor is unblocked by the disc.
